(19) United States
(12) Patent Application Publication
(10) Pub. No.: US 2026/0088543 A1
(43) Pub. Date: Mar. 26, 2026

(54) ELECTRICAL CONNECTOR

(71) Applicant: CHENG UEI PRECISION INDUSTRY CO., LTD., New Taipei City (TW)

(72) Inventors: CHAO YE, Dong-Guan City (CN); JUN CHEN, Dong-Guan City (CN)

(21) Appl. No.: 19/171,186

(22) Filed: Apr. 4, 2025

(30) Foreign Application Priority Data
Sep. 25, 2024 (CN) 202422348416.4

(51) Int. Cl. H01R 13/05; H01R 13/405; H01R 13/504; H01R 13/6581

(52) U.S. Cl. CPC H01R 13/055; H01R 13/405; H01R 13/504; H01R 13/6581

(57) ABSTRACT

An electrical connector includes a shielding shell, a tongue assembly and a plurality of the terminals. The shielding shell has an accommodating space. The tongue assembly is disposed in the accommodating space. Two opposite sides of a rear surface of the tongue assembly extend rearward to form two connecting portions, respectively. Rear ends of the two connecting portions extend towards each other to form a surrounding portion extending downward. A rear surface of the surrounding portion is recessed frontward to form a fastening groove. The plurality of the terminals are mounted in the tongue assembly. Each terminal has an extending portion. Middles of rear surfaces of the extending portions of the plurality of the terminals are exposed outside of a middle of the surrounding portion by the fastening groove.

### CROSS REFERENCE TO RELATED APPLICATIONS

The present application is based on, and claims priority from, China Patent Application No. 202422348416.4, filed Sep. 25, 2024, the disclosure of which is hereby incorporated by reference herein in its entirety.

### BACKGROUND OF THE INVENTION

### Field of the Invention

The present invention generally relates to an electrical connector, and more particularly to an electrical connector having a terminal without a burr.

### Description of Related Art

In various electrical connector types which are frequently used by various electronic products, universal serial bus (USB) connectors are the most widely applied connectors. With the improvement of sciences and technologies, more and more kinds of the universal serial bus connectors are developed, such as USB 2.0, USB 3.0, Micro USB, Mini USB or USB Type-C. The USB Type-C connectors have been widely applied in the various electronic products.

Referring to FIG. 12 to FIG. 14, a perspective view of a tongue assembly 90 of a conventional electrical connector in prior art is shown in FIG. 12 and FIG. 13. The conventional electrical connector is a USB Type-C receptacle connector. The conventional electrical connector includes the tongue assembly 90. The tongue assembly 90 includes a plurality of terminals 92, and a surrounding portion 91 disposed at a rear end of the tongue assembly 90. The plurality of the terminals 92 are disposed in the tongue assembly 90.

A rear of the tongue assembly 90 extends rearward and downward to form the surrounding portion 91. Front ends of the plurality of the terminals 92 are fastened in the tongue assembly 90. Rear ends of the plurality of the terminals 92 are exposed out of the tongue assembly 90, and then the rear ends of the plurality of the terminals 92 are bent downward. The rear ends of the plurality of the terminals 92 are surrounded by the surrounding portion 91, and the rear ends of the plurality of the terminals 92 are fastened in the surrounding portion 91. The rear ends of the plurality of the terminals 92 have a plurality of extending portions 93 extending downward. The plurality of the extending portions 93 are surrounded in the surrounding portion 91. The plurality of the extending portions 93 are fastened in the surrounding portion 91. Tail ends of the plurality of the terminals 92 are extended rearward from bottom ends of the plurality of the extending portions 93, and the tail ends of the plurality of the terminals 92 are exposed out of the surrounding portion 91.

However, in a process of molding the tongue assembly 90 by an injection molding technology, the plurality of the terminals 92 are fixed by multiple molds which are a first mold 94, a second mold 95, a third mold 96 and a fourth mold 97. The first mold 94, the second mold 95, the third mold 96 and the fourth mold 97 together define a molding cavity 98 among the first mold 94, the second mold 95, the third mold 96 and the fourth mold 97, the second mold 95 and the fourth mold 97 clamp the plurality of the terminals 92 directly to fasten the plurality of the terminals 92, so the extending portions 93 of the plurality of the terminals 92 in the molding cavity 98 are in a status which is similar to a suspended state. The plurality of the extending portions 93 which are in the status similar to the suspended state easily sway longitudinally and laterally, so friction between the plurality of the extending portions 93 and the fourth mold 97 is caused to be increased, and burrs are caused at friction positions between the plurality of the extending portions 93 and the fourth mold 97. In addition, the burrs of the extending portions 93 of the plurality of the terminals 92 are similar to burrs of a cutting surface of a metal material at the time of stamping the metal material. The burrs of the plurality of the extending portions 93 and the burrs of the cutting surface of the metal material all belong to manufacturing defects protruded from a metal surface.

Thus, it is essential to provide an innovative electrical connector, the innovative electrical connector has a terminal without a burr.

### BRIEF SUMMARY OF THE INVENTION

An object of the present invention is to provide an electrical connector having a terminal without a burr. The electrical connector includes a shielding shell, a tongue assembly and a plurality of the terminals. The shielding shell has an accommodating space penetrating through a front surface and a rear surface of the shielding shell. The tongue assembly is disposed in the accommodating space. Two opposite sides of a rear surface of the tongue assembly extend rearward to form two connecting portions, respectively. Rear ends of the two connecting portions extend towards each other to form a surrounding portion extending downward. The surrounding portion is connected between the two connecting portions. The surrounding portion has a plurality of terminal passageways, a fastening groove and a plurality of concave grooves. The plurality of the terminal passageways penetrate through a top portion of a front surface and a bottom surface of the surrounding portion. A rear surface of the surrounding portion is recessed frontward to form the fastening groove. The fastening groove is communicated with the plurality of the terminal passageways. Several portions of the bottom surface of the surrounding portion are recessed upward to form the plurality of the concave grooves. The plurality of the terminals are mounted in the tongue assembly. Front ends of the plurality of the terminals are fastened in the tongue assembly. Rear ends of the plurality of the terminals are exposed out of a rear end of the tongue assembly. Each terminal has a bending portion, an extending portion and a soldering portion. The rear end of each terminal is bent downward to form the bending portion. The bending portion of each terminal is disposed in one terminal passageway. A bottom end of the bending portion extends downward to form the extending portion. The extending portion of each terminal is disposed in the one terminal passageway. A bottom end of the extending portion extends rearward to form the soldering portion. The soldering portion of each terminal is exposed out of the one terminal passageway. The surrounding portion surrounds the bending portions of the plurality of the terminals, the extending portions of the plurality of the terminals and front ends of the soldering portions of the plurality of the terminals. Middles of rear surfaces of the extending portions of the plurality of the terminals are exposed outside of a middle of the surrounding portion by the fastening groove. Bottom portions of the extending portions of the plurality of the terminals are exposed out of the bottom surface of the surrounding portion. Front ends of inner surfaces of the soldering portions of the plurality of the terminals are exposed out of the front surface and the bottom surface of the surrounding portion. Rear ends of the soldering portions of the plurality of the terminals are exposed out of the surrounding portion.

Another object of the present invention is to provide an electrical connector. The electrical connector includes an insulating housing, and a terminal assembly fastened in the insulating housing. Two opposite sides of a rear surface of the insulating housing extend rearward to form two connecting portions, respectively. Rear ends of the two connecting portions extend towards each other to form a surrounding portion extending downward. The surrounding portion is connected between the two connecting portions. The surrounding portion has a plurality of terminal passageways and a fastening groove. The plurality of the terminal passageways penetrate through a top portion of a front surface and a bottom surface of the surrounding portion. A rear surface of the surrounding portion is recessed frontward to form the fastening groove. The fastening groove is communicated with the plurality of the terminal passageways. The terminal assembly has a plurality of terminals. Front ends of the plurality of the terminals are fastened in the insulating housing. Rear ends of the plurality of the terminals are exposed out of a rear end of the insulating housing. Each terminal has a bending portion, an extending portion and a soldering portion. A rear end of each terminal is bent downward to form the bending portion. The bending portion of each terminal is disposed in one terminal passageway. A bottom end of the bending portion extends downward to form the extending portion. The extending portion of each terminal is disposed in the one terminal passageway. A bottom end of the extending portion extends rearward to form the soldering portion. The soldering portion of each terminal is exposed out of the one terminal passageway. The surrounding portion surrounds the bending portions of the plurality of the terminals, the extending portions of the plurality of the terminals and front ends of the soldering portions of the plurality of the terminals. Middles of rear surfaces of the extending portions of the plurality of the terminals are exposed outside of a middle of the surrounding portion by the fastening groove. Bottom portions of the extending portions of the plurality of the terminals are exposed out of the bottom surface of the surrounding portion. Front ends of inner surfaces of the soldering portions of the plurality of the terminals are exposed out of the front surface and the bottom surface of the surrounding portion. Rear ends of the soldering portions of the plurality of the terminals are exposed out of the surrounding portion.

Another object of the present invention is to provide an electrical connector. The electrical connector includes an insulating housing and a plurality of terminals. Two opposite sides of a rear surface of the insulating housing extend rearward to form two connecting portions, respectively. Rear ends of the two connecting portions extend towards each other to form a surrounding portion extending downward. The surrounding portion is connected between the two connecting portions. The surrounding portion has a plurality of terminal passageways, a fastening groove and a plurality of blocking boards. The plurality of the terminal passageways penetrate through a top portion of a front surface and a bottom surface of the surrounding portion. A rear surface of the surrounding portion is recessed frontward to form the fastening groove. The fastening groove is communicated with the plurality of the terminal passageways. Each terminal passageway is formed between two adjacent blocking boards. Two opposite ends of each blocking board are connected between an upper portion and a lower portion of the surrounding portion. Middles of the plurality of the blocking boards are exposed to the fastening groove. The plurality of the terminals are mounted in the insulating housing. Front ends of the plurality of the terminals are fastened in the insulating housing. Rear ends of the plurality of the terminals are exposed out of a rear end of the insulating housing. Each terminal has a bending portion, an extending portion and a soldering portion. A rear end of each terminal is bent downward to form the bending portion. The bending portion of each terminal is disposed in one terminal passageway. A bottom end of the bending portion extends downward to form the extending portion. The extending portion of each terminal is disposed in the one terminal passageway. A bottom end of the extending portion extends rearward to form the soldering portion. The soldering portion of each terminal is exposed out of the one terminal passageway. Middles of rear surfaces of the extending portions of the plurality of the terminals are exposed outside of a middle of the surrounding portion by the fastening groove. Bottom portions of the extending portions of the plurality of the terminals are exposed out of the bottom surface of the surrounding portion. Front ends of inner surfaces of the soldering portions of the plurality of the terminals are exposed out of the front surface and the bottom surface of the surrounding portion. Rear ends of the soldering portions of the plurality of the terminals are exposed out of the surrounding portion.

As described above, the rear surface of the surrounding portion is recessed frontward to form the fastening groove, so the middles of the rear surfaces of the extending portions of the plurality of the terminals of the terminal assembly are exposed outside of the middle of the surrounding portion by the fastening groove. Furthermore, a fifth mold is increased to fasten the rear ends of the plurality of the terminals of the terminal assembly, and the fifth mold prevents the rear ends of the plurality of the terminals of the terminal assembly from moving in an injection molding process, so friction between the plurality of the terminals of the terminal assembly and the fifth mold is decreased, and burrs of the plurality of the terminals of the terminal assembly are reduced. As a result, the electrical connector has the terminal without the burr.

### BRIEF DESCRIPTION OF THE DRAWINGS

The present invention will be apparent to those skilled in the art by reading the following description, with reference to the attached drawings, in which:

FIG. 1 is partially exploded view of an electrical connector in accordance with the present invention;

FIG. 2 is a perspective view of the electrical connector of FIG. 1;

FIG. 3 is a partially exploded view of a tongue assembly of the electrical connector of FIG. 1;

FIG. 4 is an exploded view of the tongue assembly of the electrical connector of FIG. 3;

FIG. 5 is a perspective view of an insulating housing of the electrical connector of FIG. 3;

FIG. 6 is another perspective view of the insulating housing of the electrical connector of FIG. 3;

FIG. 7 is a perspective view of a terminal assembly of the electrical connector of FIG. 3;

FIG. 8 is partially sectional view of the tongue assembly of the electrical connector of FIG. 1;

FIG. 9 is a perspective view of the tongue assembly of the electrical connector of FIG. 1;

FIG. 10 is another perspective view of the tongue assembly of the electrical connector of FIG. 1;

FIG. 11 is a diagrammatic drawing showing that a plurality of molds are disposed around a rear end of a terminal of the terminal assembly at the time of molding the rear end of the terminal by an injection molding technology;

FIG. 12 is a perspective view of a tongue assembly of a conventional electrical connector in prior art;

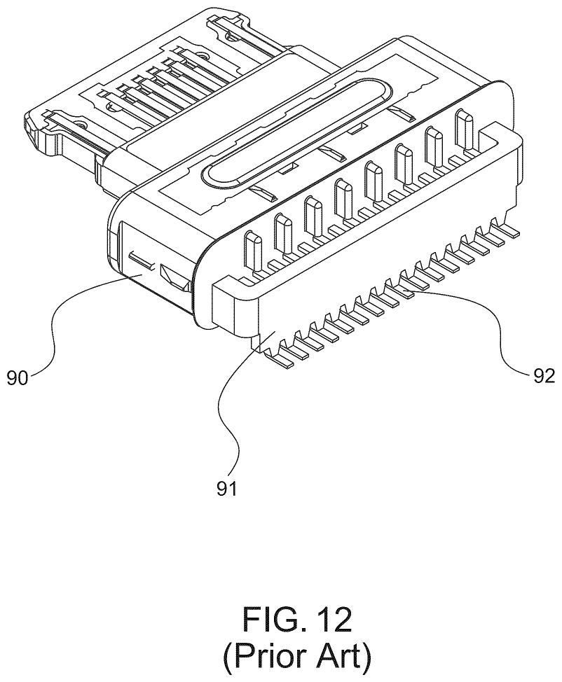

FIG. 13 is another perspective view of the tongue assembly of the conventional electrical connector in the prior art; and

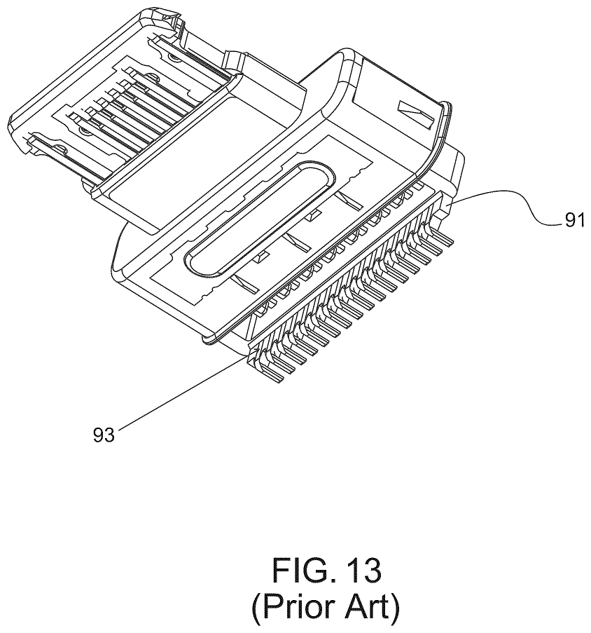

FIG. 14 is a diagrammatic drawing showing that multiple molds are disposed around a rear end of a terminal at the time of molding the rear end of the terminal by the injection molding technology.

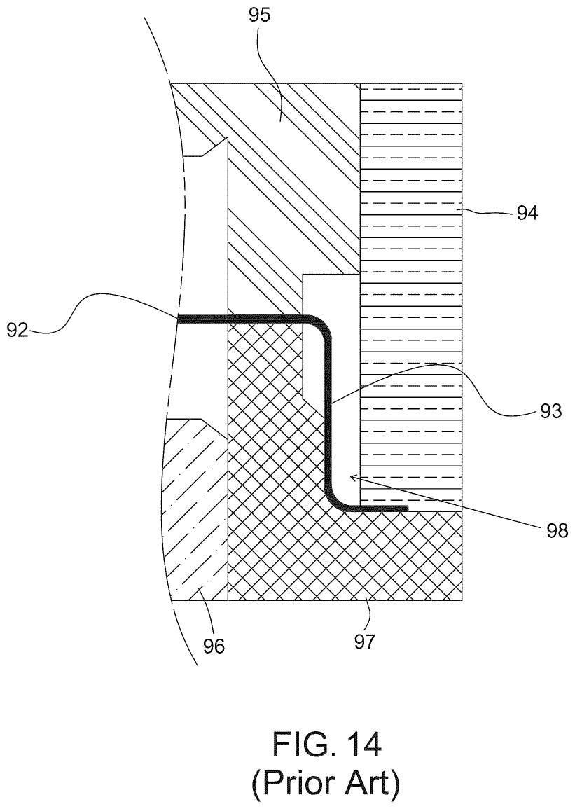

### DETAILED DESCRIPTION OF THE INVENTION

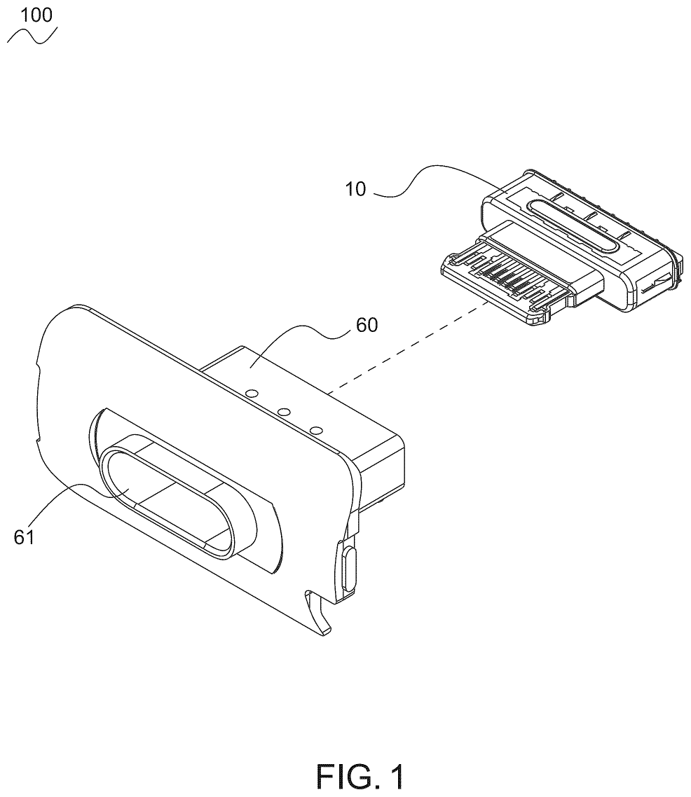

With reference to FIG. 1, in order to provide a detailed description of a technical content of an electrical connector 100 in accordance with the present invention, structural features of the electrical connector 100, objectives and effects achieved by the electrical connector 100 according to the present invention, the electrical connector 100 according to following embodiments of the present invention are given in conjunction with drawings for a detailed explanation. The electrical connector 100 in accordance with the embodiment of the present invention is a USB (Universal Serial Bus) Type-C connector, in practice, the electrical connector 100 is also able to be other types of connectors.

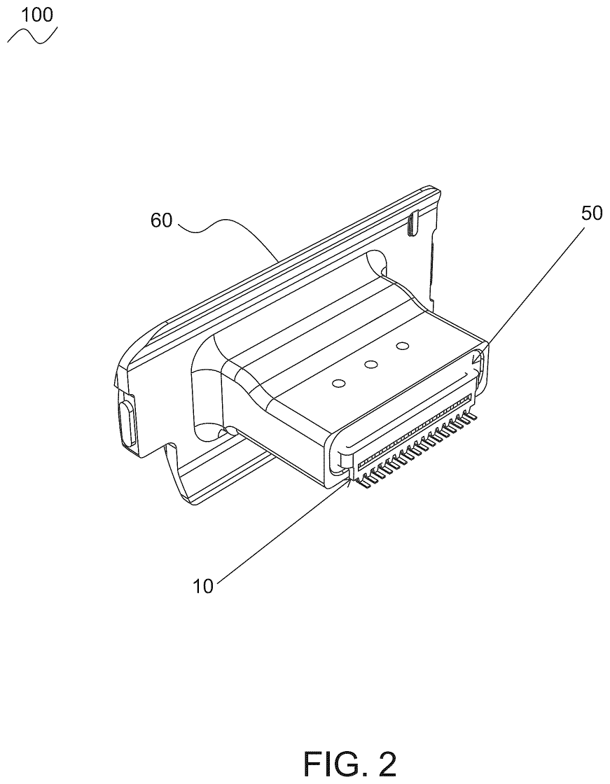

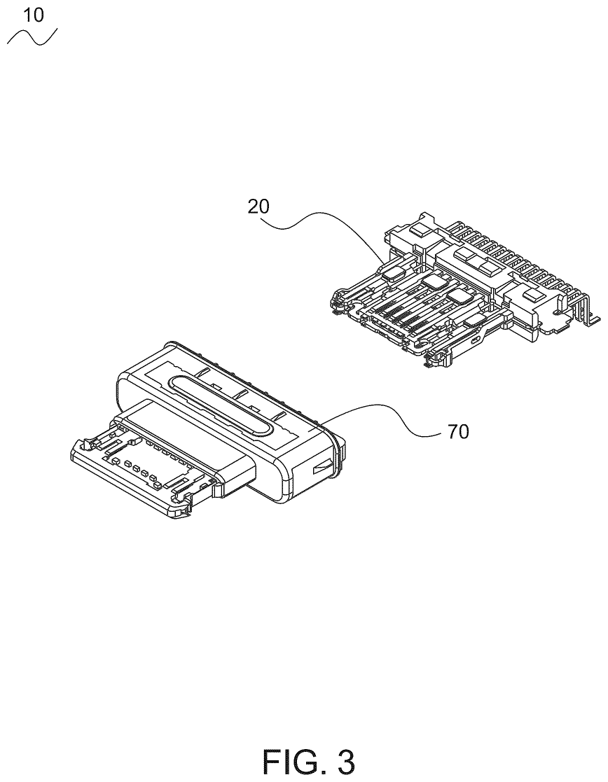

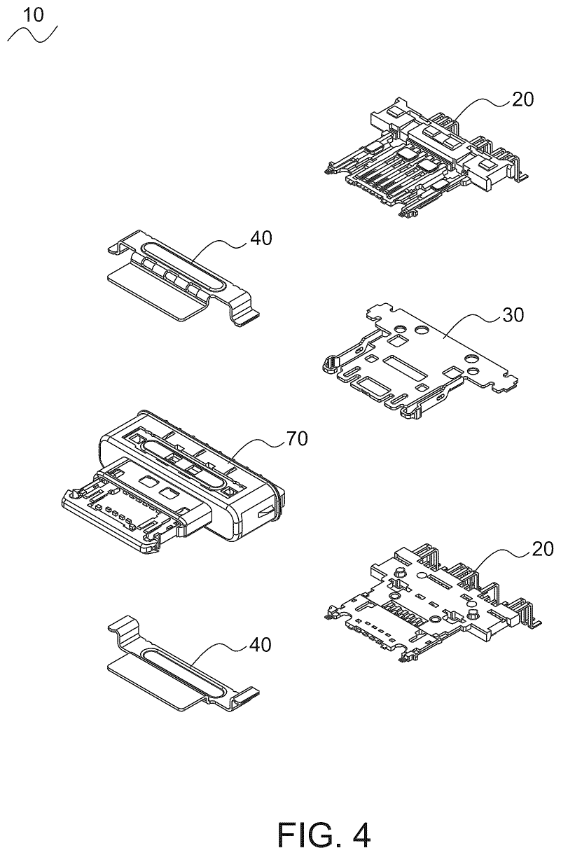

With reference to FIG. 1 to FIG. 4, the electrical connector 100 in accordance with the present invention is shown. The electrical connector 100 includes a terminal assembly 20, a middle grounding plate 30, two shielding plates 40, a glue body 50, a shielding shell 60 and an insulating housing 70. In the present invention, the electrical connector 100 is a USB Type-C connector.

The electrical connector 100 includes a tongue assembly 10. The terminal assembly 20, the middle grounding plate 30, the two shielding plates 40 and the insulating housing 70 together form the tongue assembly 10. The shielding shell 60 has an accommodating space 61 penetrating through a front surface and a rear surface of the shielding shell 60. The tongue assembly 10 is disposed in the accommodating space 61 of the shielding shell 60. The glue body 50 is coated to a rear end of the tongue assembly 10. The glue body 50 seals up a gap (not shown) between the tongue assembly 10 and the shielding shell 60. The tongue assembly 10 includes the insulating housing 70, the terminal assembly 20 assembled with the insulating housing 70, the middle grounding plate 30 mounted in a middle of the terminal assembly 20, and the two shielding plates 40 mounted to an upper portion and a lower portion of a rear end of the tongue assembly 10. The insulating housing 70 is combined with the terminal assembly 20 by way of forming in a plurality of molds.

The terminal assembly 20 is fastened in the insulating housing 70. The middle grounding plate 30 is fastened in the middle of the terminal assembly 20, and the terminal assembly 20 and the middle grounding plate 30 are fastened in the insulating housing 70. The insulating housing 70 surrounds the middle grounding plate 30 and the terminal assembly 20. The two shielding plates 40 are disposed to an upper surface and a lower surface of the insulating housing 70. The two shielding plates 40 are disposed to an upper portion and a lower portion of the rear end of the tongue assembly 10.

The glue body 50 surrounds the rear end of the tongue assembly 10. The glue body 50 surrounds a rear end of the insulating housing 70. The glue body 50 is covered to the rear end of the tongue assembly 10. The glue body 50 is covered to the rear end of the insulating housing 70. The glue body 50 seals up the gap among the terminal assembly 20, the middle grounding plate 30, the two shielding plates 40, the insulating housing 70 and the shielding shell 60, so that water is prevented from flowing into a rear end of the electrical connector 100, and the electrical connector 100 is prevented from being damaged due to a water immersion condition of the electrical connector 100. The glue body 50 surrounds a part of the terminal assembly 20.

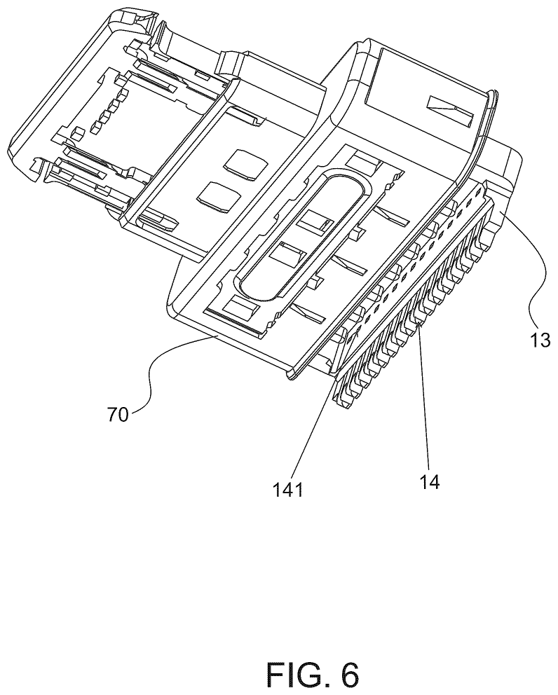

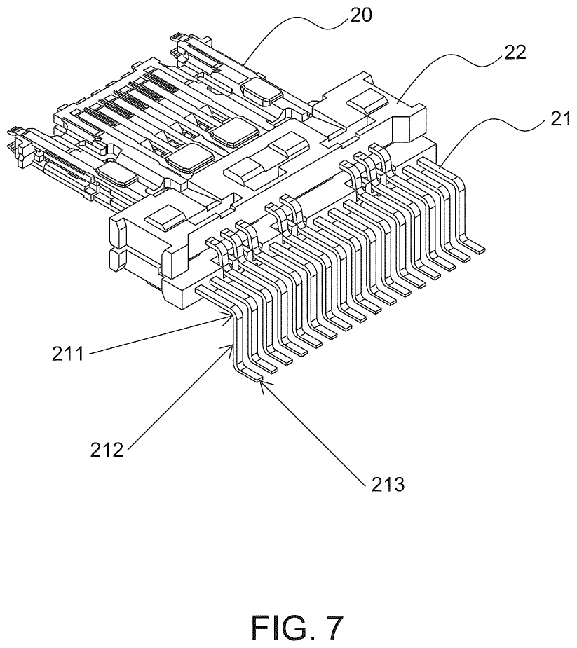

Referring to FIG. 1 to FIG. 7, the terminal assembly 20 is disposed in the insulating housing 70. The terminal assembly 20 includes a plurality of terminals 21 and a base portion 22. The plurality of the terminals 21 are mounted in the tongue assembly 10. The plurality of the terminals 21 are fastened in the base portion 22. Front ends of the plurality of the terminals 21 are fastened in the tongue assembly 10. The plurality of the terminals 21 are mounted in the insulating housing 70. The front ends of the plurality of the terminals 21 are fastened in the insulating housing 70. Rear ends of the plurality of the terminals 21 are exposed out of the rear end of the tongue assembly 10. The rear ends of the plurality of the terminals 21 are exposed out of the rear end of the insulating housing 70.

Each terminal 21 has a bending portion 211, an extending portion 212 and a soldering portion 213. The rear end of each terminal 21 is bent downward to form the bending portion 211. The bending portion 211 is disposed in a corresponding mechanism of the insulating housing 70. The bending portion 211 extends out of the rear end of the tongue assembly 10. A bottom end of the bending portion 211 extends downward to form the extending portion 212. The extending portion 212 is disposed in the corresponding mechanism of the insulating housing 70. A bottom end of the extending portion 212 extends rearward to form the soldering portion 213. The soldering portion 213 is exposed out of the insulating housing 70.

Referring to FIG. 1 to FIG. 9, in order to further fasten the plurality of the terminals 21, a rear surface of the insulating housing 70 extends rearward to form a fastening portion 11. The fastening portion 11 has two connecting portions 12 and a surrounding portion 13. Two opposite sides of a rear surface of the tongue assembly 10 extend rearward to form the two connecting portions 12, respectively. Two opposite sides of the rear surface of the insulating housing 70 extend rearward to form the two connecting portions 12, respectively. The two connecting portions 12 are connected with the rear surface of the insulating housing 70 and the surrounding portion 13. Rear ends of the two connecting portions 12 extend towards each other to form the surrounding portion 13 extending downward. The surrounding portion 13 is connected between the two connecting portions 12. The surrounding portion 13 surrounds the bending portions 211 of the plurality of the terminals 21 of the terminal assembly 20, the extending portions 212 of the plurality of the terminals 21 of the terminal assembly 20 and front ends of the soldering portions 213 of the plurality of the terminals 21 of the terminal assembly 20. The bending portions 211 of the plurality of the terminals 21 of the terminal assembly 20, the extending portions 212 of the plurality of the terminals 21 of the terminal assembly 20 and the soldering portions 213 of the plurality of the terminals 21 of the terminal assembly 20 are fastened to the surrounding portion 13. Tail ends of the soldering portions 213 of the plurality of the terminals 21 of the terminal assembly 20 are exposed out of the surrounding portion 13.

The surrounding portion 13 has a plurality of terminal passageways 14, a fastening groove 15, a plurality of concave grooves 16 and a plurality of blocking boards 17. The plurality of the terminal passageways 14 penetrate through a top portion of a front surface and a bottom surface of the surrounding portion 13. The bending portion 211 of each terminal 21 is disposed in one terminal passageway 14. The extending portion 212 of each terminal 21 is disposed in the one terminal passageway 14. The soldering portion 213 of each terminal 21 is exposed out of the one terminal passageway 14.

Each terminal passageway 14 has a connecting hole 141. The connecting hole 141 is formed at the top portion of the front surface of the surrounding portion 13. The plurality of the terminals 21 are corresponding to the connecting holes 141 of the plurality of the terminal passageways 14. A middle of a rear surface of the surrounding portion 13 is recessed frontward to form the fastening groove 15. The fastening groove 15 is communicated with the plurality of the terminal passageways 14. The fastening groove 15 is shown as a horizontal rectangular shape. Several portions of the bottom surface of the surrounding portion 13 are recessed upward to form the plurality of the concave grooves 16. Each concave groove 16 is disposed between two adjacent terminals 21 of the terminal assembly 20. Each terminal passageway 14 is formed between two adjacent blocking boards 17. Each blocking board 17 is formed between two adjacent terminal passageways 14. Two opposite ends of each blocking board 17 are connected between an upper portion and a lower portion of the surrounding portion 13. Middles of the plurality of the blocking boards 17 are exposed to a middle of the surrounding portion 13. The middles of the plurality of the blocking boards 17 are exposed to the fastening groove 15.

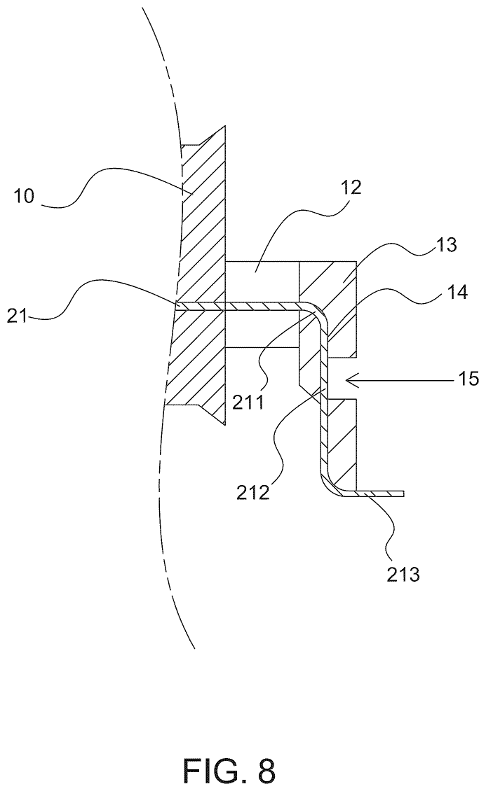

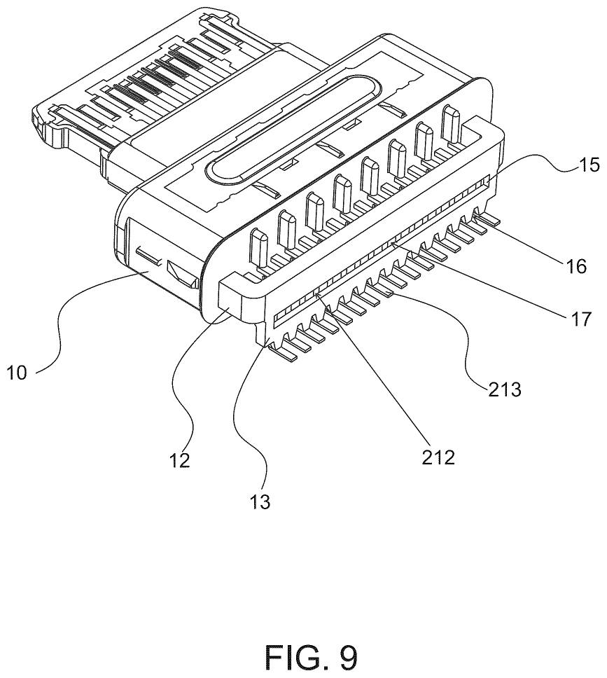

Referring to FIG. 8 and FIG. 9, each terminal 21 is inserted into the connecting hole 141 of the one terminal passageway 14. The bending portion 211 of each terminal 21 is received in the one terminal passageway 14. The bending portion 211 of each terminal 21 is disposed in the surrounding portion 13. The extending portion 212 of each terminal 21 is received in the one terminal passageway 14. The extending portion 212 of each terminal 21 is disposed in the surrounding portion 13. The soldering portion 213 of each terminal 21 is disposed to a bottom of the surrounding portion 13. Middles of rear surfaces of the extending portions 212 of the plurality of the terminals 21 of the terminal assembly 20 are exposed outside of the middle of the surrounding portion 13 by the fastening groove 15. Bottom portions of the extending portions 212 of the plurality of the terminals 21 of the terminal assembly 20 are exposed out of the bottom surface of the surrounding portion 13. Front ends of inner surfaces of the soldering portions 213 of the plurality of the terminals 21 of the terminal assembly 20 are exposed out of the front surface and the bottom surface of the surrounding portion 13. Rear ends of the soldering portions 213 of the plurality of the terminals 21 of the terminal assembly 20 are exposed out of the surrounding portion 13.

Referring to FIG. 8 and FIG. 9, upper portions of the rear ends of the plurality of the terminals 21 extend rearward, the bending portions 211 of the plurality of the terminals 21 pass through the connecting holes 141 of the plurality of the terminal passageways 14, the bending portions 211 and the extending portions 212 of the plurality of the terminals 21 are received in the plurality of the terminal passageways 14. The extending portions 212 of the plurality of the terminals 21 extend downward, and the extending portions 212 of the plurality of the terminals 21 pass through the surrounding portion 13 along the plurality of the terminal passageways 14. Bottom ends of the extending portions 212 of the plurality of the terminals 21 which are close to a bottom edge of the surrounding portion 13 are bent rearward to form the soldering portions 213 of the plurality of the terminals 21. The soldering portions 213 of the plurality of the terminals 21 horizontally extend rearward to an outside of the surrounding portion 13.

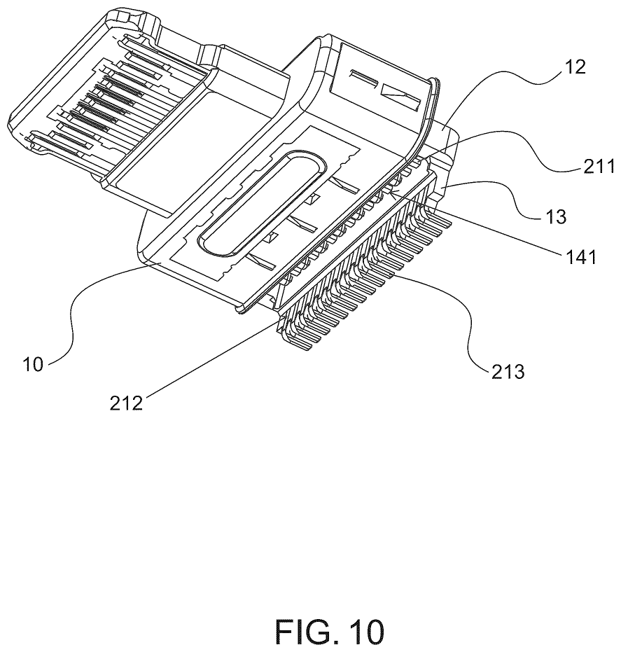

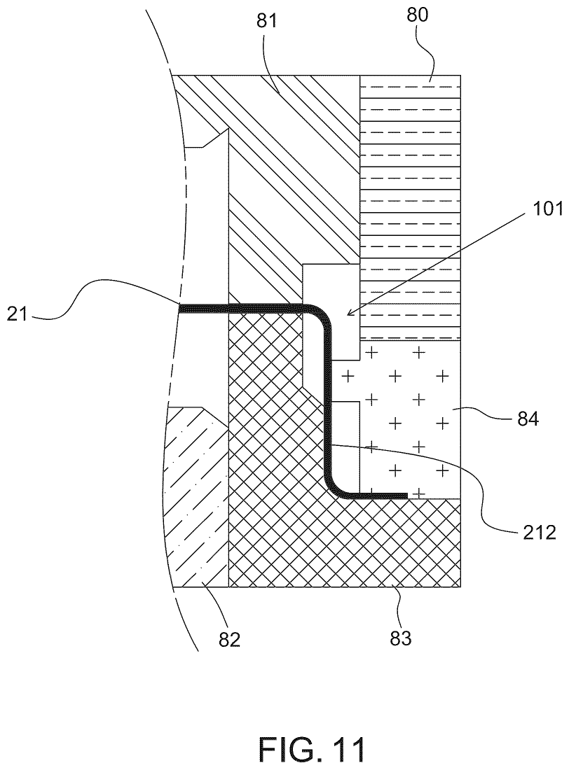

Referring to FIG. 9 to FIG. 11, the insulating housing 70 is molded by the injection molding technology. When the insulating housing 70 and the plurality of the terminals 21 of the terminal assembly 20 are molded by the injection molding technology, the plurality of the terminals 21 of the terminal assembly 20 are fixed by the plurality of the molds which are a first mold 80, a second mold 81, a third mold 82, a fourth mold 83 and a fifth mold 84. The first mold 80, the second mold 81, the third mold 82, the fourth mold 83 and the fifth mold 84 together surround a molding cavity 101 among the first mold 80, the second mold 81, the third mold 82, the fourth mold 83 and the fifth mold 84.

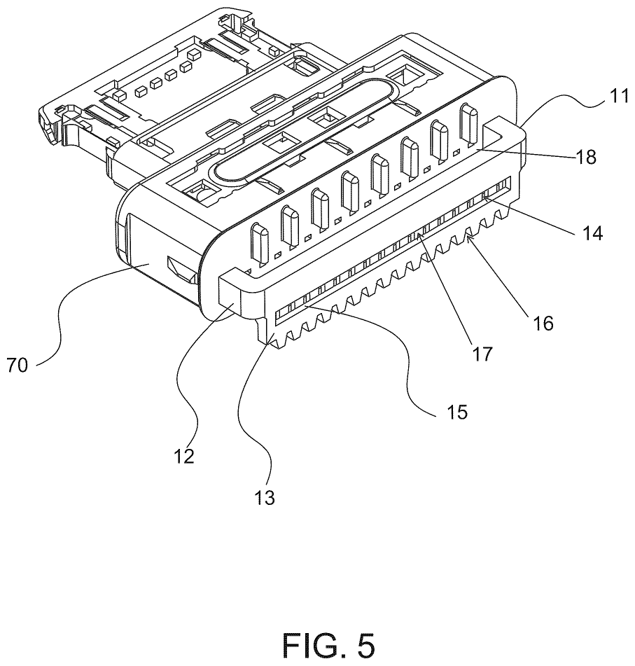

Referring to FIG. 5, the fastening portion 11 is formed by the two connecting portions 12 and the surrounding portion 13, an interval 18 is formed among the rear surface of the insulating housing 70, the two connecting portions 12 of the fastening portion 11 and the surrounding portion 13 of the fastening portion 11, so the second mold 81 and the fourth mold 83 directly clamp the plurality of the terminals 21 of the terminal assembly 20 to fasten the plurality of the terminals 21 of the terminal assembly 20. The surrounding portion 13 has the fastening groove 15 communicated with the plurality of the terminal passageways 14. The fifth mold 84 passes through the fastening groove 15, so the fifth mold 84 directly abuts against rear surfaces of the extending portions 212 of the plurality of the terminals 21 of the terminal assembly 20. A contacting area between the fifth mold 84 and the plurality of the terminals 21 of the terminal assembly 20 is increased. The fifth mold 84 is increased to fasten the rear ends of the plurality of the terminals 21 of the terminal assembly 20. When the insulating housing 70 and the plurality of the terminals 21 of the terminal assembly 20 are molded by the injection molding technology, the fifth mold 84 prevents the plurality of the terminals 21 of the terminal assembly 20 from moving, and the fifth mold 84 reduces burrs of the plurality of the terminals 21 of the terminal assembly 20.

Several portions of the bottom surface of the surrounding portion 13 are recessed upward to form the plurality of the concave grooves 16, so the fifth mold 84 further fastens the soldering portions 213 of the plurality of the terminals 21 of the terminal assembly 20 by the plurality of the concave grooves 16 of the fastening portion 11.

As described above, the rear surface of the surrounding portion 13 is recessed frontward to form the fastening groove 15, so the middles of the rear surfaces of the extending portions 212 of the plurality of the terminals 21 of the terminal assembly 20 are exposed outside of the middle of the surrounding portion 13 by the fastening groove 15. Furthermore, the fifth mold 84 is increased to fasten the rear ends of the plurality of the terminals 21 of the terminal assembly 20, and the fifth mold 84 prevents the rear ends of the plurality of the terminals 21 of the terminal assembly 20 from moving in an injection molding process, so friction between the plurality of the terminals 21 of the terminal assembly 20 and the fifth mold 84 is decreased, and the burrs of the plurality of the terminals 21 of the terminal assembly 20 are reduced. As a result, the electrical connector 100 has the terminal 21 without the burr.

Though the present invention is disclosed as the above-mentioned embodiment, the embodiment disclosed in this invention is without being intended to limit a scope of this invention. In related technical fields, anyone with ordinary knowledges should be able to make a few changes and embellishments within a spirit and a protection scope of this invention, so the protection scope of this invention should regard defined claims of an attached application patent as a standard.

What is claimed is:

1. An electrical connector, comprising:
a shielding shell having an accommodating space penetrating through a front surface and a rear surface of the shielding shell;
a tongue assembly disposed in the accommodating space, two opposite sides of a rear surface of the tongue assembly extending rearward to form two connecting portions, respectively, rear ends of the two connecting portions extending towards each other to form a surrounding portion extending downward, the surrounding portion being connected between the two connecting portions, the surrounding portion having a plurality of terminal passageways, a fastening groove and a plurality of concave grooves, the plurality of the terminal passageways penetrating through a top portion of a front surface and a bottom surface of the surrounding portion, a rear surface of the surrounding portion being recessed frontward to form the fastening groove, the fastening groove being communicated with the plurality of the terminal passageways, several portions of the bottom surface of the surrounding portion being recessed upward to form the plurality of the concave grooves; and
a plurality of terminals mounted in the tongue assembly, front ends of the plurality of the terminals being fastened in the tongue assembly, rear ends of the plurality of the terminals being exposed out of a rear end of the tongue assembly, each terminal having a bending portion, an extending portion and a soldering portion, the rear end of each terminal being bent downward to form the bending portion, the bending portion of each terminal being disposed in one terminal passageway, a bottom end of the bending portion extending downward to form the extending portion, the extending portion of each terminal being disposed in the one terminal passageway, a bottom end of the extending portion extending rearward to form the soldering portion, the soldering portion of each terminal being exposed out of the one terminal passageway, the surrounding portion surrounding the bending portions of the plurality of the terminals, the extending portions of the plurality of the terminals and front ends of the soldering portions of the plurality of the terminals, middles of rear surfaces of the extending portions of the plurality of the terminals being exposed outside of a middle of the surrounding portion by the fastening groove, bottom portions of the extending portions of the plurality of the terminals being exposed out of the bottom surface of the surrounding portion, front ends of inner surfaces of the soldering portions of the plurality of the terminals being exposed out of the front surface and the bottom surface of the surrounding portion, rear ends of the soldering portions of the plurality of the terminals being exposed out of the surrounding portion.

2. The electrical connector as claimed in claim 1, wherein the fastening groove is shown as a horizontal rectangular shape.

3. The electrical connector as claimed in claim 1, wherein the surrounding portion has a plurality of blocking boards, each blocking board is formed between two adjacent terminal passageways, two opposite ends of each blocking board are connected between an upper portion and a lower portion of the surrounding portion, middles of the plurality of the blocking boards are exposed to the fastening groove.

4. The electrical connector as claimed in claim 1, wherein tail ends of the soldering portions of the plurality of the terminals are exposed out of the surrounding portion.

5. The electrical connector as claimed in claim 1, wherein each terminal passageway has a connecting hole, the connecting hole is formed at the top portion of the front surface of the surrounding portion, the plurality of the terminals are corresponding to the connecting holes of the plurality of the terminal passageways, the bending portions of the plurality of the terminals pass through the connecting holes of the plurality of the terminal passageways, the bending portions and the extending portions of the plurality of the terminals are received in the plurality of the terminal passageways.

6. The electrical connector as claimed in claim 1, wherein the tongue assembly has an insulating housing and a terminal assembly, the terminal assembly includes the plurality of the terminals, the insulating housing is combined with the terminal assembly by way of forming in a plurality of molds.

7. The electrical connector as claimed in claim 6, wherein the plurality of the terminals are fixed by the plurality of the molds which are a first mold, a second mold, a third mold, a fourth mold and a fifth mold.

8. The electrical connector as claimed in claim 7, wherein the two connecting portions and the surrounding portion are extended from a rear surface of the insulating housing, an interval is formed among the rear surface of the insulating housing, the two connecting portions and the surrounding portion, so the second mold and the fourth mold directly clamp the plurality of the terminals from a top direction and a bottom direction.

9. The electrical connector as claimed in claim 7, wherein the fifth mold passes through the fastening groove, so the fifth mold directly abuts against rear surfaces of the extending portions of the plurality of the terminals.

10. An electrical connector, comprising:
an insulating housing, two opposite sides of a rear surface of the insulating housing extending rearward to form two connecting portions, respectively, rear ends of the two connecting portions extending towards each other to form a surrounding portion extending downward, the surrounding portion being connected between the two connecting portions, the surrounding portion having a plurality of terminal passageways and a fastening groove, the plurality of the terminal passageways penetrating through a top portion of a front surface and a bottom surface of the surrounding portion, a rear surface of the surrounding portion being recessed frontward to form the fastening groove, the fastening groove being communicated with the plurality of the terminal passageways; and
a terminal assembly fastened in the insulating housing, the terminal assembly having a plurality of terminals, front ends of the plurality of the terminals being fastened in the insulating housing, rear ends of the plurality of the terminals being exposed out of a rear end of the insulating housing, each terminal having a bending portion, an extending portion and a soldering portion, a rear end of each terminal being bent downward to form the bending portion, the bending portion of each terminal being disposed in one terminal passageway, a bottom end of the bending portion extending downward to form the extending portion, the extending portion of each terminal being disposed in the one terminal passageway, a bottom end of the extending portion extending rearward to form the soldering portion, the soldering portion of each terminal being exposed out of the one terminal passageway, the surrounding portion surrounding the bending portions of the plurality of the terminals, the extending portions of the plurality of the terminals and front ends of the soldering portions of the plurality of the terminals, middles of rear surfaces of the extending portions of the plurality of the terminals being exposed outside of a middle of the surrounding portion by the fastening groove, bottom portions of the extending portions of the plurality of the terminals being exposed out of the bottom surface of the surrounding portion, front ends of inner surfaces of the soldering portions of the plurality of the terminals being exposed out of the front surface and the bottom surface of the surrounding portion, rear ends of the soldering portions of the plurality of the terminals being exposed out of the surrounding portion.

11. The electrical connector as claimed in claim 10, wherein the fastening groove is shown as a horizontal rectangular shape.

12. The electrical connector as claimed in claim 10, wherein the surrounding portion has a plurality of blocking boards, each blocking board is formed between two adjacent terminal passageways, two opposite ends of each blocking board are connected between an upper portion and a lower portion of the surrounding portion, middles of the plurality of the blocking boards are exposed to the fastening groove.

13. The electrical connector as claimed in claim 10, wherein the insulating housing is combined with the terminal assembly by way of forming in a plurality of molds.

14. The electrical connector as claimed in claim 13, wherein the plurality of the terminals are fixed by the plurality of the molds which are a first mold, a second mold, a third mold, a fourth mold and a fifth mold.

15. The electrical connector as claimed in claim 14, wherein an interval is formed among the rear surface of the insulating housing, the two connecting portions and the surrounding portion, so the second mold and the fourth mold directly clamp the plurality of the terminals from a top direction and a bottom direction.

16. The electrical connector as claimed in claim 14, wherein the fifth mold passes through the fastening groove, so the fifth mold directly abuts against rear surfaces of the extending portions of the plurality of the terminals.

17. An electrical connector, comprising:
an insulating housing, two opposite sides of a rear surface of the insulating housing extending rearward to form two connecting portions, respectively, rear ends of the two connecting portions extending towards each other to form a surrounding portion extending downward, the surrounding portion being connected between the two connecting portions, the surrounding portion having a plurality of terminal passageways, a fastening groove and a plurality of blocking boards, the plurality of the terminal passageways penetrating through a top portion of a front surface and a bottom surface of the surrounding portion, a rear surface of the surrounding portion being recessed frontward to form the fastening groove, the fastening groove being communicated with the plurality of the terminal passageways, each terminal passageway being formed between two adjacent blocking boards, two opposite ends of each blocking board being connected between an upper portion and a lower portion of the surrounding portion, middles of the plurality of the blocking boards being exposed to the fastening groove; and
a plurality of terminals mounted in the insulating housing, front ends of the plurality of the terminals being fastened in the insulating housing, rear ends of the plurality of the terminals being exposed out of a rear end of the insulating housing, each terminal having a bending portion, an extending portion and a soldering portion, a rear end of each terminal being bent downward to form the bending portion, the bending portion of each terminal being disposed in one terminal passageway, a bottom end of the bending portion extending downward to form the extending portion, the extending portion of each terminal being disposed in the one terminal passageway, a bottom end of the extending portion extending rearward to form the soldering portion, the soldering portion of each terminal being exposed out of the one terminal passageway, middles of rear surfaces of the extending portions of the plurality of the terminals being exposed outside of a middle of the surrounding portion by the fastening groove, bottom portions of the extending portions of the plurality of the terminals being exposed out of the bottom surface of the surrounding portion, front ends of inner surfaces of the soldering portions of the plurality of the terminals being exposed out of the front surface and the bottom surface of the surrounding portion, rear ends of the soldering portions of the plurality of the terminals being exposed out of the surrounding portion.
